(19) United States
(12) Patent Application Publication
(10) Pub. No.: US 2006/0037534 A1
(43) Pub. Date: Feb. 23, 2006

(54) System for treating, in particular, cataphoretically immersion painting objects, particularly vehicle bodies

(76) Inventor: Hans-Joachim Weinand, Ditzingen (DE)

Correspondence Address: FACTOR & LAKE, LTD, 1327 W. WASHINGTON BLVD., SUITE 5G/H, CHICAGO, IL, 60607, US

(21) Appl. No.: 10/507,089

(22) PCT Filed: Feb. 1, 2003
(86) PCT No.: PCT/EP03/01008

§ 371 Date: Jul. 18, 2005

(30) Foreign Application Priority Data
Mar. 13, 2002 (DE) 102-10-981.8

(51) Int. Cl. B05C 3/10; B65G 49/02

(52) U.S. Cl. 118/423; 118/426; 198/346.1

(57) ABSTRACT

A system for treating, in particular, cataphoretically immersion painting objects, particularly vehicle bodies comprises a number of treatment reservoirs (101, 102, 103) inside of which the objects (4) can each be subjected to the action of a treatment liquid. The objects (4) are guided one by one through the treatment reservoirs (101, 102, 103) with the aid of at least one trolley (5). Said trolley comprises a traveling mechanism (7, 8, 9 to 12) that can travel along the movement path of the objects (4). This trolley also comprises at least one pivotal arm (50, 51) that is coupled to the traveling mechanism (2, 8, 9 to 12), and has a holding device (61), which is coupled to said pivotal arm and provided for holding at least one object (4). Independent drives (32, 35, 56, 57, 80, 81) ensure that the translatory motion of the trolley (5), the pivoting of the at least one pivotal arm (50, 51), and the pivoting of the holding device (61) can be executed independent of one another. This trolley (5) enables the objects (4), which are to be treated, to be held for a long duration at an angle to the horizontal while being located in the outlet area of the treatment reservoirs (101, 102, 103) above the zone in which they are subjected to the action of the treatment liquid. This permits the treatment liquid to flow and drip off back into the treatment reservoirs (101, 102, 103).

The invention relates to a system for treating, in particular for cataphoretically dip-coating, articles, in particular vehicle bodies, comprising
a) a plurality of treatment containers, in which the articles may be acted upon in each case by a treatment liquid;
b) a feed device, by means of which the articles are conveyed through the system and in the process are dipped successively into the treatment containers.

In coating systems for vehicle bodies, but also for other articles, there are a number of treatment containers, in which the articles are acted upon by a treatment liquid. Here, by “acted upon” is meant both the wave-flow treatment, the spraying and the immersion of the articles with and/or into the treatment liquid. By “wave-flow treatment” is meant an operation, in which relatively large quantities of treatment liquid are applied onto the articles per unit of time. Such wave-flow treatment is used, for example, for the primary cleaning of vehicle bodies in the so-called pre-treatment zone. By spraying is meant the generation of a very fine spray mist, which penetrates into every nook, cranny and otherwise inaccessible point of the articles to be treated. Such spraying operations are used, for example, both for the cleaning and for the phosphatizing, passivation or activation and the follow-up treatments of surfaces. In the case of immersion, the articles are, as the name suggests, submerged in a bath. Immersion operations are used, for example, likewise for cleaning and the other processes that occur in the pre-treatment zone, but also in the coating operation itself.

In every case, it is important that an entrainment of treatment liquid from one treatment container into the next treatment bath be prevented as far as possible. The main purpose of this is to prevent the composition of the treatment liquid in the next treatment bath from being varied; a further purpose however is to minimize the depletion of treatment liquid owing to entrainment.

A system of the initially described type is described in DE 196 41 048 C2. Here, the feed device comprises two continuous chains, to which so-called “bogies” are fastened rotatably about a horizontal axis, which bogies in turn each carry a vehicle body. By virtue of a first rotation of the bogies through 180° the vehicle bodies are immersed into a treatment area, which may be a bath, and by virtue of a second rotation through 180° they are lifted out of the treatment area. The rotational movements are in said case derived from the translational movement by means of a link device. As it is not possible to stop the individual vehicle bodies at a specific point and as the articles in the known system are to be lifted out of the bath as close to the end of the treatment bath as possible, the articles after leaving the treatment containers still carry a relatively large amount of treatment liquid along with them. Between two successive containers it is therefore necessary to provide so-called “dripping zones”, during the crossing of which the treatment liquid may run off the articles, thereby allowing the liquid entrainment into the next bath to be kept low. These dripping zones however increase the length of the overall system, this always entailing considerable costs.

The object of the present invention is to develop a system of the initially described type in such a way that it has a shorter overall length.

This object is achieved according to the invention in that
c) the feed device comprises at least one feed carriage, which in turn comprises:
   ca) running gear movable along the path of motion of the articles;
   cb) at least one swivel arm coupled to the running gear;
   cc) a holding device coupled to the swivel arm for at least one article;
   cd) mutually independently actuable drives for the translational movement, the swivelling of the at least one swivel arm and of the holding device;
d) at least two treatment containers are disposed one immediately downstream of the other without the interposition of a dripping zone.

In the present invention a feed carriage is used, which is known as such from DE-U-201 05 676. This describes in detail exclusively the dipping of an article into and out of a single treatment bath. With the present invention it is recognized that the known feed carriage allows special kinematics for the articles fed by them in the outlet region of the individual treatment containers. The articles may namely be brought by a suitably coordinated movement in the three degrees of freedom, which the feed carriage provides, into a position in the outlet region of the treatment containers, in which they are situated above the zone, in which they are acted upon by treatment liquid, in an angular position relative to the horizontal that allows the treatment liquid to run and drip off. In this position of the articles, the translational movement of the feed carriages may be halted for a short time until all of the treatment liquid has run back into the appropriate treatment container. It is only then that the translational movement of the feed carriage is resumed and the article, which is then almost completely free of the treatment liquid of the preceding treatment container, is introduced into the next treatment container. Dripping zones between the treatment containers are therefore redundant, thereby correspondingly shortening the overall length of the system.

The kinematics of the articles that are used during the dripping-off operation may be adapted to the respective article, e.g. by adjusting different angles, in particular angles in opposite directions relative to the horizontal.

There now follows a detailed description of an embodiment of the invention with reference to the drawings; the drawings show

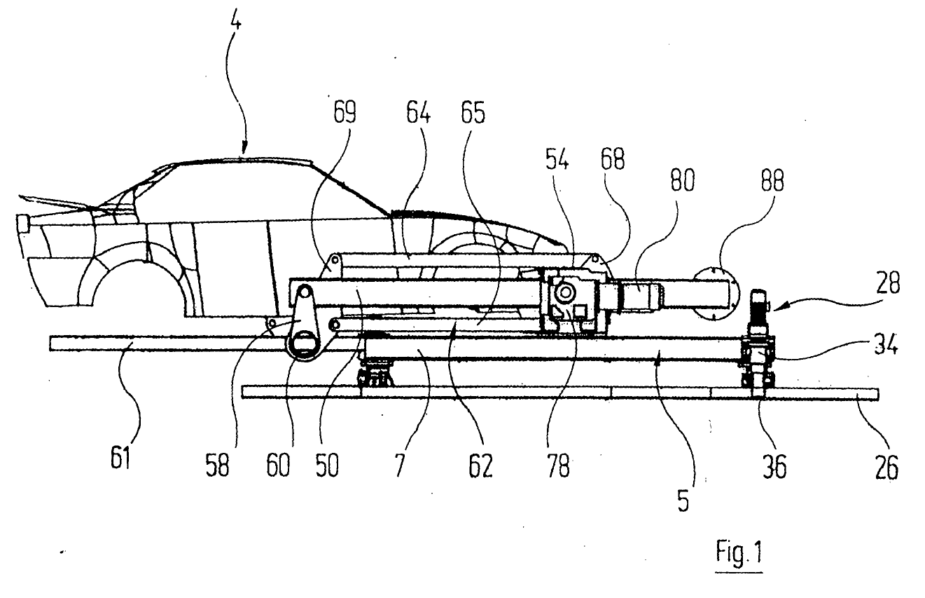

FIG. 1: a side view of a feed carriage used in the coating system, with a vehicle body fastened thereon in normal feed position;

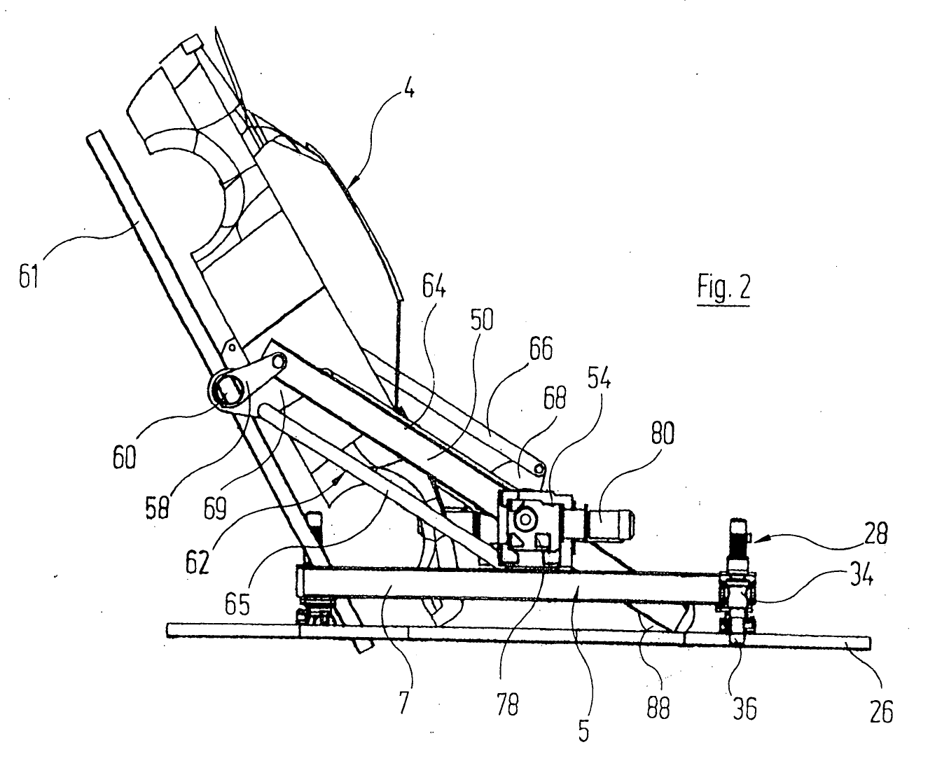

FIG. 2: a side view of the feed carriage similar to FIG. 1, in which however the vehicle body is swivelled out of the feed position;

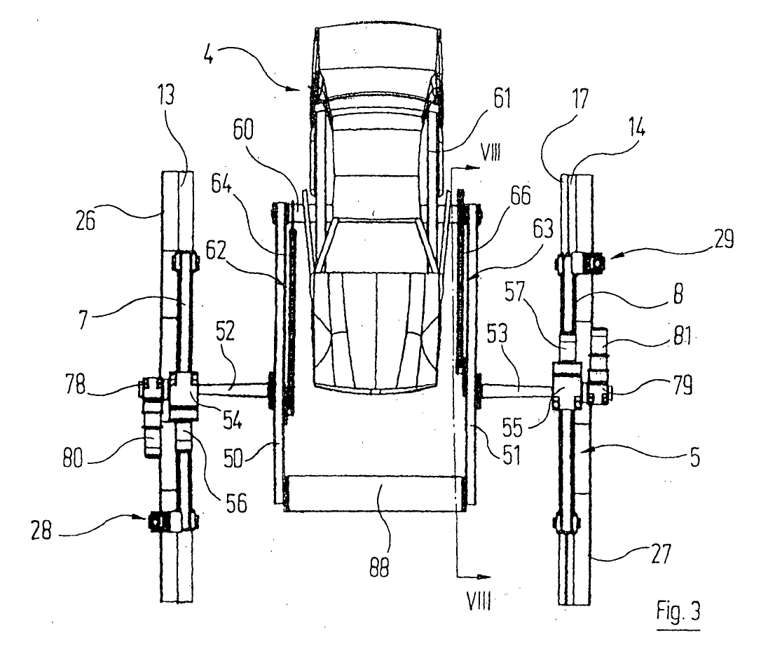

FIG. 3: the plan view of the feed carriage of FIG. 2;

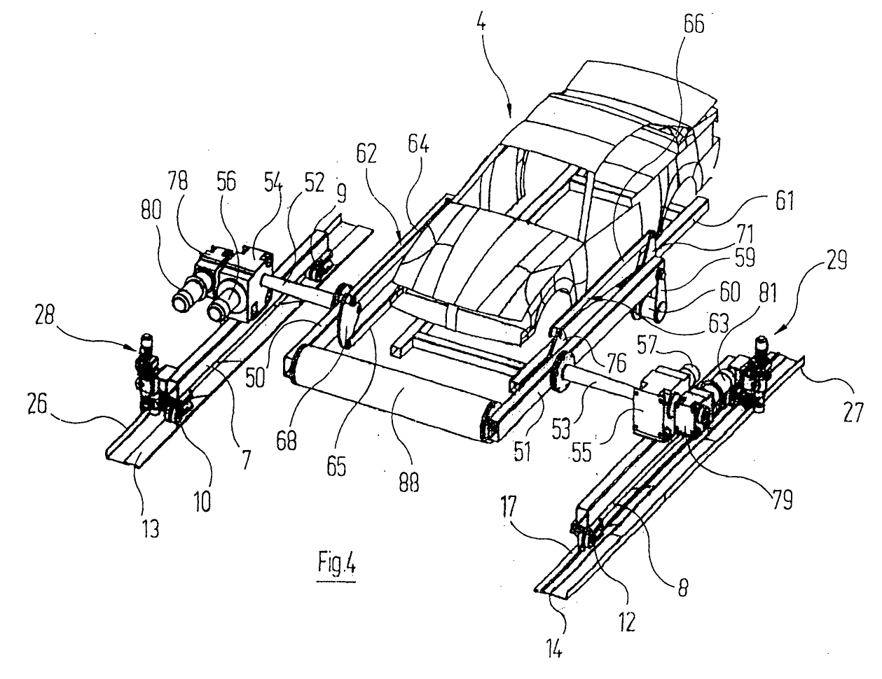

FIG. 4: a perspective view of the feed carriage plus vehicle body of FIG. 1;

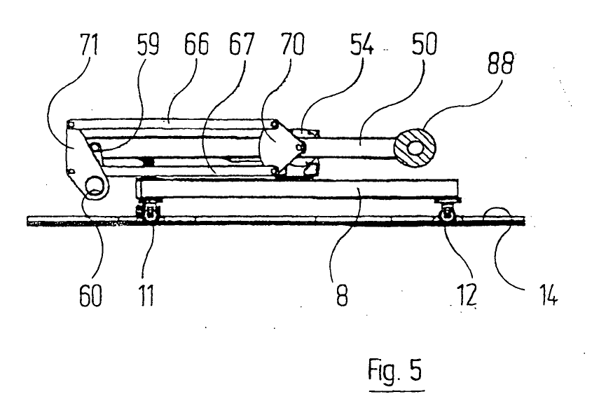

FIG. 5: a section through FIG. 3 according to the line VIII-VIII of FIG. 3;

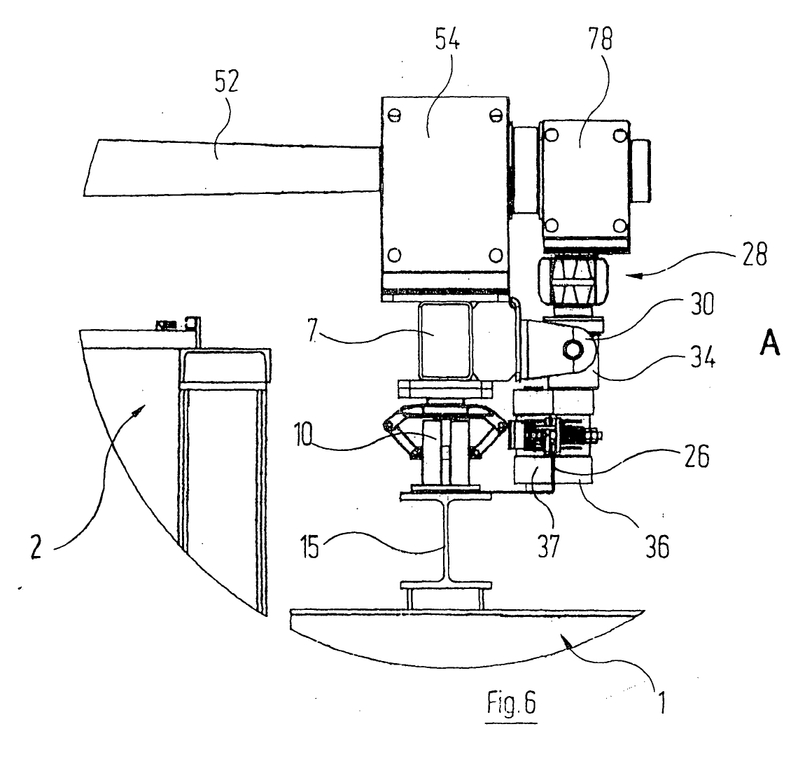

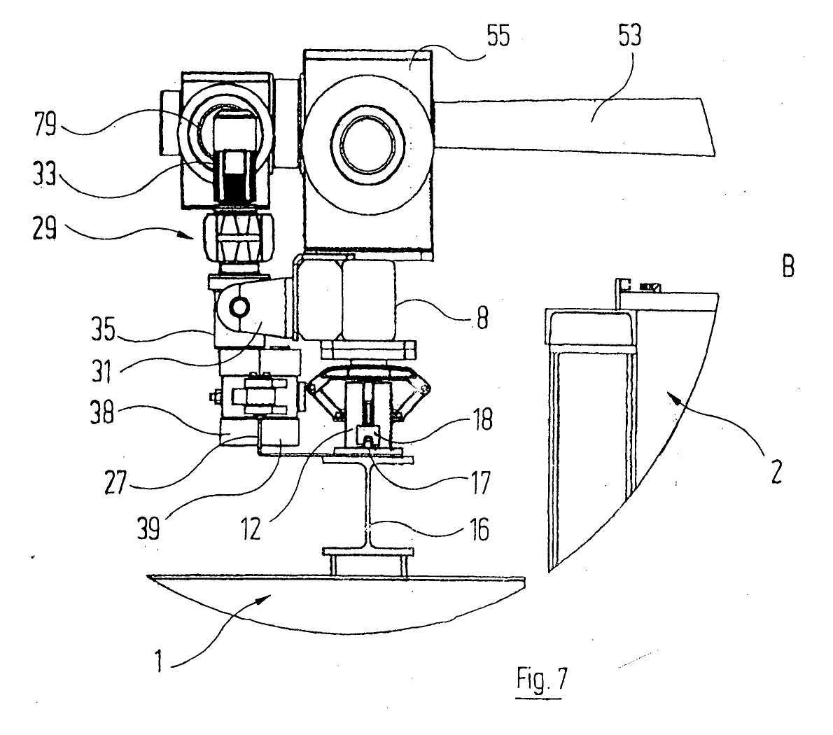

FIGS. 6 and 7: enlarged detail views of the feed carriage in the region of the wheels positioned on running surfaces;

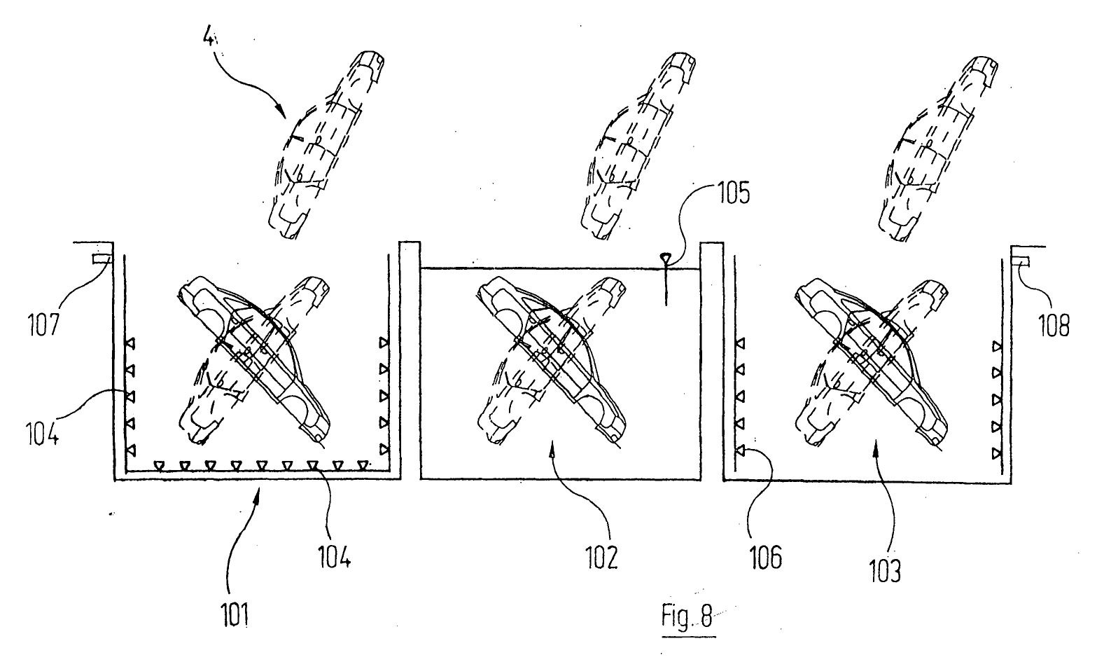

FIG. 8: a detail comprising three treatment containers from the pre-treatment zone of a coating system.

First, there now follows a detailed description with reference to FIGS. 1 to 7 of the style of construction of feed carriages 5 of the type used in the coating system illustrated in the further drawings. Such feed carriages 5 are admittedly known in principle from DE-U-201 05 676, to which additionally reference is made. However, since a knowledge of the kinematics of these feed carriages 5 is a prerequisite to an understanding of the overall system, the explanation of the feed carriages 5 is repeated to the necessary extent in the present description.

As FIGS. 3 and 4 in particular reveal, each feed carriage 5 has two longitudinal tie-bars 7, 8, at the underside of each of which two twin wheels 9, 10 and 11, 12 are mounted rotatably about a horizontal axis. The wheels 9 to 12 are additionally rotatable in each case with the aid of a not specifically illustrated swivelling bolster about a vertical axis, with the result that the alignment of the twin wheels 9 to 12 relative to the respective longitudinal tie-bars 7, 8 may be varied.

The twin wheels 9, 10 roll along a first running surface 13 and the twin wheels 11, 12 roll along a second running surface 14 parallel to the first. The running surfaces 13, 14 are in turn mounted in each case on an I-beam 15, 16, which is supported by a non-illustrated steel structure.

In the middle of the, in FIGS. 3 and 4 right, second running surface 14 a guide rib 17 is provided, over which guide elements 18 having a complementary recess (cf. FIG. 7) engage. In each case one guide element 18 is connected to the swivelling bolster of an associated twin wheel 11 and/or 12 in such a way that it rotates this twin wheel 11 and/or 12 about the vertical axis in accordance with the course of the guide rib 17. The twin wheels 11, 12 therefore follow the running surface 14. The twin wheels 9, 10 associated with the first, in FIGS. 3 and 4 left running surface 13, on the other hand, are designed purely as trailing wheels; in other words, no separate guide means are provided for influencing the angular position of the wheels about their vertical axis of rotation. In this way, the standards of accuracy demanded of the guide means that hold the feed carriages 5 on the running surfaces 13, 14 may be kept low.

Vehicle bodies 4 are carried on the feed carriages 5 with the aid of an immersion apparatus, which comprises one swivelling apparatus on each side of the vehicle bodies 4. Each of these swivelling apparatuses has a swivel arm 50, 51, which in a manner yet to be described may swivel in a vertical plane extending parallel to the feed direction. For this purpose, each swivel arm 50, 51 is connected by a stub shaft 52, 53, which extends at right angles to the feed direction, to the output shaft of a gear unit 54, 55. The gear unit 54, 55 is fastened to the respective longitudinal tie-bar 7, 8 of the feed carriage 5 approximately in the central region thereof. It is driven by a motor 56 and/or 57, which is flange-mounted laterally on the gear unit 54, 55.

The, in direction of motion, rear ends of the swivel arms 50, 51 are hinge-connected to a link 58, 59, which in the normal feed position shown in FIG. 1 extends vertically downwards from the corresponding swivel arm 50, 51. The bottom ends of the links 58, 59 are connected to one another by a transverse tie-bar 60, which extends at right angles to the direction of motion and is in turn connected rigidly to the central region of a support platform 61 for the vehicle body 4. The direction of extension of the two links 58, 59 in said case runs at right angles to the plane of the support platform 61.

The angular position that the links 58, 59 occupy relative to the swivel arms 50, 51 is determined in each case by an adjusting device, which as a whole bears the reference character 62 and/or 63. Each of these adjusting devices 62, 63 comprises a linkage having two parallel push rods 64, 65 and/or 66, 67, which at their opposite ends are connected to one another in each case by a connecting strap 68, 69 and/or 70, 71. The, in direction of motion, rear connecting straps 69 and/or 71 are fastened at their bottom end rigidly to the transverse tie-rod 60.

The, in direction of motion, front connecting straps 70, 71, on the other hand, are connected rigidly in each case to a stub shaft, which is not visible in the drawings because it extends coaxially through the associated stub shaft 52, 53 designed as a hollow shaft. These further stub shafts extend also through the gear units 54, 55 and are coupled to the output shafts of further gear units 78, 79, which are fastened laterally to the gear units 54, 55. Drive motors 80, 81 are also flange-mounted laterally onto the gear units 78, 79.

The front ends of the two swivel arms 50, 51 jointly carry a counterweight 88, so that the torques acting upon the stub shafts 52, 53 are approximately counterbalanced when a vehicle body 4 is placed on.

The twin wheels 9 to 12 of the feed carriages 5 are not themselves driven. Rather, forward propulsion of the feed carriages 5 is effected by means of a separate drive, which is described in detail below with reference to FIGS. 3 to 7.

Extending parallel to the two running surfaces 13, 14 are two vertically aligned, stationary driving flanges 26, 27. These interact in each case with a press roller drive 28 and/or 29, which is fastened to the lateral surface of the adjacent longitudinal tie-bar 7, 8 by means of a link 30 and/or 31. The press roller drives 28, 29 each comprise an electric drive motor 32, 33 and a drive gear unit 34, 35. The latter drives the parallel, vertical axles of two press rollers 36, 37 and/or 38, 39, which are pressed from both sides against the respective associated driving flange 26 and/or 27. When the drive motors 32, 33 are energized, the press rollers 36, 37 and/or 38, 39 run along the respective lateral surfaces of the driving flanges 26, 27 and, in so doing, move the feed carriage 5 forward along the running surfaces 13, 14.

Each feed carriage 5 comprises its own carriage controller, under the regime of which it executes both its translational movement along the running surfaces 13, 14 and the swivelling motions of the swivel arms 50, 51 and of the support platform 61.

In summary, the movement options of a vehicle body 4 carried on a feed carriage 5 may be described as follows:

The overall movement arises from a superposition of the linear translational movement of the feed carriage 5, a first swivelling motion that the swivel arms 50, 51 execute relative to the longitudinal tie-bars 7, 8 and is linked to a lifting and/or lowering of the vehicle body 4, and a second swivelling motion that the vehicle body 4 situated on the support platform 61 executes relative to the swivel arms 50, 51. All of these types of movement may be carried out completely independently of one another, thereby leading to practically any desired kinematics of the vehicle body 4. In the previously described embodiment of a feed carriage 5, the swivelling motion is transmitted to the support platform 61 from the motors 80, 81 by means of linkage-like adjusting devices 62, 63. Naturally, the adjusting devices may however be designed differently, e.g. they may comprise continuous metal belts as torque-transmitting elements.

Reference is now made to FIG. 8, which shows the detail of a coating system that is of relevance in the present context. In this drawing, a vehicle body 4 is shown at different points as well as at different levels and angles relative to the horizontal. This vehicle body 4 is to be imagined as being carried by a feed carriage 5. The feed carriage itself is not illustrated for the sake of clarity. That the vehicle body 4 may occupy the respective positions, and how it does so, is however plain from the previous description of the feed carriage 5.

FIG. 8 shows three treatment containers 101, 102, 103, which are disposed successively in the “direction of net movement” of the feed carriages 5 and hence of the vehicle bodies 4. By “direction of net movement” is meant a movement that, on the whole, extends in FIG. 8 from left to right but does not rule out that temporary reversals of motion also occur. Such a temporary reversal of motion may be used, for example, to lift a vehicle body 4 practically vertically. In this case, the component of motion of the vehicle body 4 in horizontal direction that is linked to the swivelling motion of the swivel arms 50, 51 is cancelled out by a corresponding translational movement of the feed carriage 5. Such a temporary reversal of motion of the feed carriage 5 may also be useful for achieving other kinematics of the vehicle body 4.

The treatment containers 101, 102 and 103 are situated in a pre-treatment zone, in which the vehicle bodies 4 are prepared for a cataphoretic dip-coating operation. Disposed on the walls and on the base of the first treatment container 101 is a number of wave-flow nozzles 104, by means of which the vehicle body 4 introduced with the aid of the feed carriage 5 into the treatment container 101 may be acted upon by an effusion of a treatment liquid, e.g. a lye. By virtue of a corresponding movement of the holding device 61, on which the vehicle body 4 is situated, the vehicle body 4 is swivelled to and fro inside the treatment container 101 in such a way that, on the one hand, the treatment liquid may reach all of the surfaces of the vehicle body 4, even into poorly accessible angles and optionally cavities, and, on the other hand, the treatment liquid and any impurities entrained thereby are washed off the vehicle body 4 and out of the cavities thereof.

On completion of this wave-flow operation, the vehicle body 4 is lifted out of the treatment container 101 with the aid of the feed carriage 5, wherein the vehicle body 4, as is illustrated on the right above the treatment container 101, is set at a very steep angle not far off 90° relative to the horizontal. The feed carriage 5 remains in the corresponding position, in which the vehicle body 4 is situated above the outlet region of the treatment container 101, until the treatment liquid applied by means of the wave-flow nozzles 104 has extensively flowed back into the treatment container 101 and dripped off the vehicle body 4. The vehicle body 4 may then be moved on and introduced directly into the next treatment container 102 by the feed carriage 5 without any risk of liquid entrainment. There is therefore no need to insert a dripping zone between the successive treatment containers 101, 102. The treatment containers 101, 102 may lie with their walls practically in direct mutual abutment.

In the treatment container 102 an immersion degreasing of the vehicle bodies 4 occurs. For this purpose, the treatment container 102 is filled up to a specific level 105 with a degreasing liquid, e.g. likewise a lye. The feed carriage 5, by virtue of a corresponding movement of the type described e.g. also in the previously mentioned DE-U-201 05 676, immerses the vehicle body 4 into the treatment container 102 and the degreasing liquid situated therein and in the course of passage of the vehicle body 4 through the treatment container 102, where necessary, swivels the vehicle body 4 to and fro for improved access and drainage of the degreasing liquid to and/or from all of the surfaces of the vehicle body 4, including the cavities thereof.

In the outlet region of the second treatment container 102 the vehicle body 4 is lifted out in the same way as described above for the treatment container 101: after removal from the degreasing liquid, the vehicle body 4 is set in the illustrated manner at a steep angle relative to the horizontal. Further movement of the feed carriage 5 is suspended until the degreasing liquid has extensively flowed back into the treatment container 102 and dripped off the vehicle body 4.

The feed carriage 5 then moves the vehicle body 4 further on and, by virtue of a corresponding superposition of its translational movement and the swivelling motions of swivel arms 50, 51 and support platform 61, lowers the vehicle body 4 into the third treatment container 103.

On the walls of the treatment container 103 a number of spray nozzles 106 are situated, by means of which the vehicle body 4 is sprayed with degreasing liquid. The spray nozzles 106 generate a fine spray jet that penetrates into every angle and cavity of the vehicle body 4. This penetration is likewise improved by suitable swivelling motions of the vehicle body 4, which are executed by the feed carriage 5.

At the end of the treatment container 103 the vehicle body 4 is lifted out in the same way as has already been described for the treatment containers 101 and 102. In the raised position of the vehicle body 4 at a steep angle to the horizontal above the outlet region of the treatment container 103, the degreasing liquid flows back into the treatment container 103 and drips off the vehicle body 4. The vehicle body 4 may then be e.g. returned to its normal horizontal position on the feed carriage 5 and fed to a further, non-illustrated processing station.

1. A system for treating articles comprising:
a plurality of treatment containers, in which the articles may be acted upon in each case by a treatment liquid;
a feed device, by means of which the articles are conveyed through the system and in the process are dipped successively into the treatment containers,
the feed device comprising at least one feed carriage which in turn comprising:
running gear movable along the path of motion of the articles;
at least one swivel arm coupled to the running gear;
a holding device coupled to the swivel arm for at least one article and,
mutually independently actuable drives for translational movement, the swivelling of the at least one swivel arm and of the holding device; and,
at least two treatment containers disposed one immediately downstream of the other without the interposition of a dripping zone.
